(19) United States
(12) Patent Application Publication
(10) Pub. No.: US 2021/0245892 A1
(43) Pub. Date: Aug. 12, 2021

(54) UNMANNED AERIAL VEHICLE CONTROL METHOD, UNMANNED AERIAL VEHICLE, AND TERMINAL FOR CONTROLLING UNMANNED AERIAL VEHICLE

(71) Applicant: SZ DJI TECHNOLOGY CO., LTD., Shenzhen (CN)

(72) Inventors: Chao MA, Shenzhen (CN); Yongsen CHEN, Shenzhen (CN); Chuantang XIONG, Shenzhen (CN)

(21) Appl. No.: 17/243,561

(22) Filed: Apr. 28, 2021

Related U.S. Application Data
(63) Continuation of application No. PCT/CN2018/112447, filed on Oct. 29, 2018.

(51) Int. Cl. B64D 45/00; B64C 39/02; G08G 5/00; G05D 1/00

(52) U.S. Cl. CPC B64D 45/00; B64C 39/024; B64D 2045/0065; G05D 1/0022; B64C 2201/12; G08G 5/003

(57) ABSTRACT

An unmanned aerial vehicle control method includes sending an acquisition instruction to a terminal upon detecting a trigger signal. The acquisition instruction is used to instruct the terminal to return verification information. The method further includes receiving the verification information returned by the terminal, and controlling an unmanned aerial vehicle to perform a corresponding operation and/or enable a corresponding function corresponding to the trigger signal in response to the verification information matching preset verification information.

### CROSS-REFERENCE TO RELATED APPLICATION

This application is a continuation of International Application No. PCT/CN2018/112447, filed Oct. 29, 2018, the entire content of which is incorporated herein by reference.

### TECHNICAL FIELD

The present disclosure relates to the technical field of unmanned aerial vehicle control and, more particularly, to an unmanned aerial vehicle control method, an unmanned aerial vehicle, and a terminal for controlling the unmanned aerial vehicle.

### BACKGROUND

In related technologies, a pilot can connect to an unmanned aerial vehicle to operate it after a successful login on APP. For the same unmanned aerial vehicle, if other pilots are successfully logged in by using their accounts and passwords respectively, all other pilots can operate the unmanned aerial vehicle as well, resulting in a potential safety hazard of the unmanned aerial vehicle.

### SUMMARY

In accordance with the disclosure, there is provided an unmanned aerial vehicle control method including sending an acquisition instruction to a terminal upon detecting a trigger signal. The acquisition instruction is used to instruct the terminal to return verification information. The method further includes receiving the verification information returned by the terminal, and controlling an unmanned aerial vehicle to perform a corresponding operation and/or enable a corresponding function corresponding to the trigger signal in response to the verification information matching preset verification information.

Also in accordance with the disclosure, there is provided an unmanned aerial vehicle including a storage device storing preset verification information and a processor that is electrically coupled to the storage device. The processor is configured to send an acquisition instruction to a terminal upon detecting a trigger signal. The acquisition instruction is used to instruct the terminal to return verification information. The processor is further configured to receive the verification information returned by the terminal, and control the unmanned aerial vehicle to perform a corresponding operation and/or enable a corresponding function corresponding to the trigger signal in response to the verification information matching the preset verification information.

Also in accordance with the disclosure, there is provided a terminal including a storage device storing program instructions and a processor configured to execute the program instructions to receive an acquisition instruction sent by an unmanned aerial vehicle. The acquisition instruction is used to instruct the terminal to return verification information. The processor is further configured to execute the program instructions to display the acquisition instruction, and send the verification information input by user in regard to the acquisition instruction to the unmanned aerial vehicle.

### BRIEF DESCRIPTION OF THE DRAWINGS

In order to explain the technical solutions in the embodiments of the present disclosure more clearly, reference is made to the accompanying drawings, which are used in the description of the embodiments. Obviously, the drawings in the following description are only some embodiments of the present disclosure, and other drawings can be obtained from these drawings without any inventive effort for those of ordinary skill in the art.

FIG. 1 is a flow chart of an example unmanned aerial vehicle control method consistent with the present disclosure.

FIG. 2 is a structural diagram of an example unmanned aerial vehicle consistent with the present disclosure.

FIG. 3 is a flow chart of another example unmanned aerial vehicle control method consistent with the present disclosure.

FIG. 4 is a structural diagram of an example terminal consistent with the present disclosure.

FIG. 5 is a flow chart of another example unmanned aerial vehicle control method consistent with the present disclosure.

FIG. 6 is a structural diagram of another example unmanned aerial vehicle consistent with the present disclosure.

FIG. 7 is a flow chart of another example unmanned aerial vehicle control method consistent with the present disclosure.

FIG. 8 is a structural diagram of another example terminal consistent with the present disclosure.

### DETAILED DESCRIPTION OF THE EMBODIMENTS

The technical solutions in the embodiments of the present disclosure will be described in detail with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

Hereinafter, an unmanned aerial vehicle control method, an unmanned aerial vehicle, and a terminal for controlling the unmanned aerial vehicle in the present disclosure will be described in detail with reference to the accompanying drawings. In the case of no conflict, the following embodiments and features in the embodiments can be combined with each other.

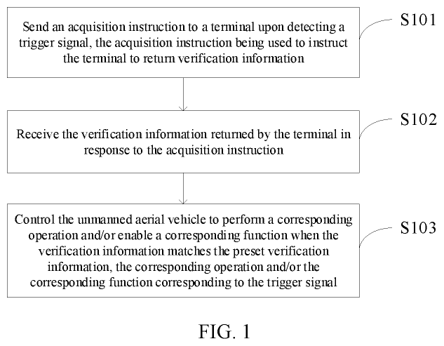

FIG. 1 is a flow chart of an example unmanned aerial vehicle control method consistent with the present disclosure. The execution subject of the unmanned aerial vehicle control method shown in FIG. 1 can be an unmanned aerial vehicle. Referring to FIG. 1, the unmanned aerial vehicle control method includes the following processes.

S101: Sending an acquisition instruction to a terminal upon detecting a trigger signal, the acquisition instruction being used to instruct the terminal to return verification information.

The unmanned aerial vehicle can automatically trigger to generate the trigger signal, or it can passively detect the trigger signal. For example, in one embodiment, the unmanned aerial vehicle automatically triggers to generate trigger information, and specifically, the trigger signal is generated when the unmanned aerial vehicle meets a specific strategy. For example, when the unmanned aerial vehicle detects that the unmanned aerial vehicle is currently in a specific location area, it determines that the unmanned aerial vehicle meets a specific strategy. In a specific embodiment, the unmanned aerial vehicle is an agricultural plant protection machine. When it is detected that the agricultural plant protection machine is currently in area A, a trigger signal for instructing the agricultural plant protection machine to spray pesticide 1 is generated; when it is detected that the agricultural plant protection machine is currently in area B, a trigger signal for instructing the agricultural plant protection machine to spray pesticide 2 is generated. In another specific embodiment, the unmanned aerial vehicle is an aerial photography unmanned aerial vehicle, and when it is detected that the aerial photography unmanned aerial vehicle is currently in area C, a trigger signal for instructing the aerial photography unmanned aerial vehicle to shoot is generated.

For example, when the unmanned aerial vehicle detects that the unmanned aerial vehicle is currently in a specific time period, it determines that the unmanned aerial vehicle meets a specific strategy. In a specific embodiment, the unmanned aerial vehicle is an agricultural plant protection machine. When it is detected that the agricultural plant protection machine is currently in time period X, a trigger signal for instructing the agricultural plant protection machine to spray pesticide 1 is generated; when it is detected that the agricultural plant protection machine is currently in time period Y, a trigger signal for instructing the agricultural plant protection machine to spray pesticide 2 is generated. In another specific embodiment, the unmanned aerial vehicle is an aerial photography unmanned aerial vehicle. When it is detected that the aerial photography unmanned aerial vehicle is currently in time period Z, a trigger signal for instructing the aerial photography unmanned aerial vehicle to shoot is generated.

For example, when the unmanned aerial vehicle detects that the unmanned aerial vehicle is currently in a specific location area and the unmanned aerial vehicle is currently in a specific time period, it determines that the unmanned aerial vehicle meets a specific strategy. The specific location area and time period can be set according to actual needs. In a specific embodiment, the unmanned aerial vehicle is an agricultural plant protection machine. When it is detected that the agricultural plant protection machine is currently in area A and the agricultural plant protection machine is currently in time period X, a trigger signal for instructing the agricultural plant protection machine to spray pesticide 1 is generated; when it is detected that the agricultural plant protection machine is currently in area B and the agricultural plant protection machine is currently in time period Y, a trigger signal for instructing the agricultural plant protection machine to spray pesticide 2 is generated. In another specific embodiment, the unmanned aerial vehicle is an aerial photography unmanned aerial vehicle, and when it is detected that the aerial photography unmanned aerial vehicle is currently in area C and the aerial photography unmanned aerial vehicle is currently in time period Z, a trigger signal for instructing the aerial photography unmanned aerial vehicle to shoot is generated.

It is understandable that whether the unmanned aerial vehicle meets a specific strategy can also be judged from other aspects, which is not limited to the current location of the unmanned aerial vehicle and the current time of the unmanned aerial vehicle as listed in the embodiments described above.

In another embodiment, the unmanned aerial vehicle passively detects the trigger signal. In some embodiments, when the unmanned aerial vehicle receives an operation request, it determines that the trigger signal is detected. According to the present embodiment, a corresponding operation request is generated based on user's operation of the unmanned aerial vehicle. The operation request may include an access request, a power-on request, a connection request, a verification information modification request, a shutdown request, and/or another request for operating the unmanned aerial vehicle.

In some embodiments, the unmanned aerial vehicle includes a first storage device for storing one or more of image information (pictures and/or videos) and flight log. It can be understood that the first storage device may also be configured to store other data obtained by the unmanned aerial vehicle during flight. The first storage device in some embodiments may be an SSD solid state hard disk, an SD card, or another types of memory unit.

In some embodiments, the access request is used to instruct an external device to access the first storage device, the power-on request is used to instruct to start the unmanned aerial vehicle, the connection request is used to instruct to connect a remote control to the unmanned aerial vehicle, the verification information modification request is used to instruct to modify preset verification information, and the shutdown request is used to instruct to turn off verification protection function of the unmanned aerial vehicle.

When the operation request is to turn off the verification protection function of the unmanned aerial vehicle, the unmanned aerial vehicle control method of the present embodiment further includes, before a verification request is sent to the terminal, detecting that the unmanned aerial vehicle has turned on the verification protection function. In some embodiments, the unmanned aerial vehicle needs to be controlled to turn on the verification protection function before detecting that the unmanned aerial vehicle has turned on the verification protection function.

In some embodiments, the unmanned aerial vehicle automatically turns on the verification protection function when it detects that the unmanned aerial vehicle meets a preset rule (such as the unmanned aerial vehicle is currently in a specific location area and/or the unmanned aerial vehicle is currently in a specific time period). In some other embodiments, the verification protection function of the unmanned aerial vehicle is turned on by a user trigger. For example, if a trigger instruction sent by the terminal is received, the verification protection function of the unmanned aerial vehicle is turned on. The trigger instruction is used to instruct the unmanned aerial vehicle to turn on the verification protection function.

S102: Receiving the verification information returned by the terminal in response to the acquisition instruction.

In some embodiments, after receiving the acquisition instruction sent by the unmanned aerial vehicle, the terminal will display the acquisition instruction and inform user to input verification information. For example, the terminal pops up an input box in response to the acquisition instruction, and the input box is used to instruct the user to input verification information. Of course, the terminal may also display the acquisition instruction in another manner.

S103: Controlling the unmanned aerial vehicle to perform a corresponding operation and/or enable a corresponding function when the verification information matches the preset verification information, the corresponding operation and/or the corresponding function corresponding to the trigger signal.

In one embodiment, when the verification information returned by the terminal is the same as the preset verification information, it is determined that the verification information returned by the terminal matches the preset verification information. For example, the preset verification information is a preset verification code which may be composed of numbers, symbols, etc. When the verification information returned by the terminal is the preset verification code, the verification is passed. Of course, in some other embodiments, the manner for the unmanned aerial vehicle to determine whether the verification information returned by the terminal matches the preset verification information is not limited to this. For example, the unmanned aerial vehicle recalculates the verification information returned by the terminal based on an algorithm. When the calculated verification information is the same as the preset verification information, it is determined that the verification information returned by the terminal matches the preset verification information.

In some embodiments, the preset verification information is stored in the first storage device.

In addition, in some embodiments, the preset verification information corresponding to different trigger signals is the same. For example, when the unmanned aerial vehicle is in area A, the trigger signal is used to instruct the unmanned aerial vehicle to perform task 1; when the unmanned aerial vehicle is in area B, the trigger signal is used to instruct the unmanned aerial vehicle to perform task 2. In some embodiments, the preset verification information corresponding to the trigger signal used to instruct the unmanned aerial vehicle to perform task 1 is the same as the preset verification information corresponding to the trigger signal used to instruct the unmanned aerial vehicle to perform task 2. While the unmanned aerial vehicle is safely operated, it is convenient for users to remember the preset verification information.

In some other embodiments, the preset verification information corresponding to different trigger signals is different. For example, the preset verification information corresponding to different areas (where the unmanned aerial vehicle is located) is different, the preset verification information corresponding to different time periods is different, and the preset verification information corresponding to different operation requests is different. Through this setting method, the unmanned aerial vehicle has different verification information for different areas and/or different time periods and/or different operation requests, which further improves the safe operation of the unmanned aerial vehicle. It is especially suitable for scenarios where the unmanned aerial vehicle is used by different users.

In a specific scenario, the preset verification information corresponding to different areas is different. For example, pilot A is allowed to control the unmanned aerial vehicle in area A, and pilot B is allowed to control the unmanned aerial vehicle in area B, and the preset verification information corresponding to the unmanned aerial vehicle in area A is different from the preset verification information corresponding to the unmanned aerial vehicle in area B to ensure the safe operation of the unmanned aerial vehicle. In some embodiments, the preset verification information can be set by different users, such as by the owner or manager of the unmanned aerial vehicle, and then pilot A and pilot B are notified of the set preset information.

In another specific scenario, the preset verification information corresponding to different operation requests is different. For example, the preset verification information corresponding to the access request and the preset verification information corresponding to the verification information modification request are different. After the owner or manager of the unmanned aerial vehicle has set the preset verification information corresponding to the access request and the verification information modification request, he can inform pilot A of the preset verification information corresponding to the access request, and inform pilot B of the preset verification information corresponding to the verification information modification request, so that pilot A has the authority to access the first storage device of the unmanned aerial vehicle, and pilot B has the authority to modify the verification information, thereby restricting the usage authority of pilots.

Of course, the scenario corresponding to the setting of the preset verification information is not limited to the manners listed in the embodiments described above, and the preset verification information can also be set according to the requirement for use.

When the trigger instruction is generated by automatically trigger of the unmanned aerial vehicle, the corresponding operations and/or corresponding functions may include one or more of the following: allowing external device to access the first storage device, starting the unmanned aerial vehicle, connecting the remote control to the unmanned aerial vehicle, allowing modification of the preset verification information, and turning off the verification protection function of the unmanned aerial vehicle. Of course, the corresponding operations and/or corresponding functions are not limited to the operations and/or functions listed above, and are not limited to the manners listed in the embodiments described above.

When the trigger instruction is generated by user operation of the unmanned aerial vehicle, the unmanned aerial vehicle needs to be controlled to perform the corresponding operation and/or enable the corresponding function according to user's operation request. For example, when the operation request is the access request, an external device is allowed to access the first storage device if the verification information matches the preset verification information. After the unmanned aerial vehicle allows the external device to access the first storage device, the external device can obtain data information from the first storage device, such as image information obtained by the unmanned aerial vehicle at a specific time and/or flight log, providing secure access to data storage of the unmanned aerial vehicle and protecting the data information of the unmanned aerial vehicle. In some embodiments, allowing external device to access the first storage device includes enabling a communication link between the external device and the unmanned aerial vehicle. For example, the communication link between the external device and the unmanned aerial vehicle can be a wired communication link, such as a USB communication link. As another example, the communication link between the external device and the unmanned aerial vehicle can be a wireless communication link, such as a Bluetooth communication link or a wifi communication link.

For example, when the operation request is the power-on request, the unmanned aerial vehicle is turned on if the verification information matches the preset verification information.

For example, when the operation request is the connection request, the remote controller is connected to the unmanned aerial vehicle if the verification information matches the preset verification information. Specifically, the remote control is connected to the communication frequency band of the unmanned aerial vehicle.

For example, when the operation request is the verification information modification request, the preset verification information is allowed to be modified if the verification information matches the preset verification information, and the user can modify the preset verification information as needed. Specifically, after the preset verification information is allowed to be modified, if the verification information to be set is received, the preset verification information is replaced with the verification information to be set, thereby completing the modification process of the preset verification information.

For example, when the operation request is the shutdown request, the verification protection function of the unmanned aerial vehicle is turned off if the verification information matches the preset verification information. After the verification protection function of the unmanned aerial vehicle is turned off, the unmanned aerial vehicle directly performs the corresponding operation and/or enables the corresponding function after detecting the trigger signal.

In some embodiments, after the verification information returned by the terminal in response to the acquisition instruction is received, the corresponding operation and/or function of the unmanned aerial vehicle is locked if the verification information does not match the preset verification information. For example, when the trigger signal is the access request, the external device is not allowed to access the first storage device if the unmanned aerial vehicle determines that the verification information returned by the terminal does not match the preset verification information. When the trigger signal is the power-on request, the unmanned aerial vehicle is not allowed to start if it determines that the verification information returned by the terminal does not match the preset verification information. When the trigger signal is the connection request, the remote control currently requesting connection is not allowed to connect to the unmanned aerial vehicle if the unmanned aerial vehicle determines that the verification information returned by the terminal does not match the preset verification information. When the trigger signal is the verification information modification request, it is not allowed to modify the preset verification information if the unmanned aerial vehicle determines that the verification information returned by the terminal does not match the preset verification information. When the trigger signal is the shutdown request, the unmanned aerial vehicle is not allowed to turn off the enabled verification protection function if it determines that the verification information returned by the terminal does not match the preset verification information.

According to the present disclosure, by creating user operation restrictions on the unmanned aerial vehicle, when the unmanned aerial vehicle is triggered, the user needs to input correct verification information before the unmanned aerial vehicle can perform the corresponding operation and/or enable the corresponding function, so as to ensure the safety of the unmanned aerial vehicle. In this way, even if the unmanned aerial vehicle is physically attacked, it can be ensured that the unmanned aerial vehicle will not be illegally operated.

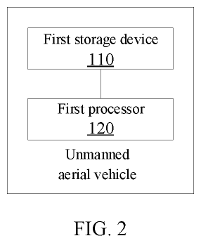

Corresponding to the unmanned aerial vehicle control method in the embodiments described above, the present disclosure also provides an unmanned aerial vehicle. Referring to FIG. 2, the unmanned aerial vehicle includes a first storage device 110 and a first processor 120, where the first storage device 110 stores preset verification information and the first processor 120 is electrically coupled to the first storage device 110.

When the first processor 120 detects a trigger signal, it sends an acquisition instruction to a terminal, the acquisition instruction being used to instruct the terminal to return verification information; receives the verification information returned by the terminal in response to the acquisition instruction; when the verification information matches preset verification information, controls the unmanned aerial vehicle to perform a corresponding operation and/or enable a corresponding function, where the corresponding operation and/or the corresponding function corresponds to the trigger signal.

The first processor 120 can implement a corresponding method consistent with the present disclosure such as the method described above in connection with FIG. 1. The unmanned aerial vehicle control method described above can be referred to for details of operations/functions of the unmanned aerial vehicle, which will not be repeated herein.

In some embodiments, the first storage device 110 may include a volatile memory such as a random-access memory (RAM). The first storage device 110 may include a non-volatile memory such as a flash memory (flash memory), a hard disk drive (HDD), or a solid-state drive (SSD). The first storage device 110 may include a combination of memories of different types described above.

The first processor 120 may be a central processing unit (CPU). The first processor 120 may include a hardware chip such as an application-specific integrated circuit (ASIC), a programmable logic device (PLD), or a combination thereof. The PLD can be a complex programmable logic device (CPLD), a field-programmable gate array (FPGA), a generic array logic (GAL) or any combination thereof.

For example, the first processor 120 is a flight controller or another controller provided at the unmanned aerial vehicle, or a combination of the flight controller and the other controller provided at the unmanned aerial vehicle.

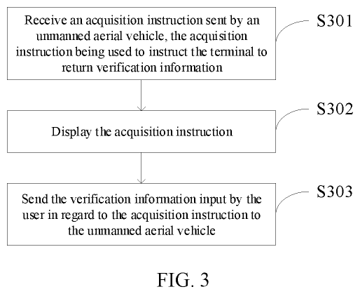

FIG. 3 is a flow chart of another example unmanned aerial vehicle control method consistent with the present disclosure. The execution subject of the unmanned aerial vehicle control method shown in FIG. 3 can be a terminal. Referring to FIG. 3, the unmanned aerial vehicle control method includes the following processes.

S301: Receiving an acquisition instruction sent by an unmanned aerial vehicle, the acquisition instruction being used to instruct the terminal to return verification information.

The unmanned aerial vehicle generates the acquisition instruction after detecting a trigger signal. For the manner of judging whether the unmanned aerial vehicle detects the trigger signal, reference can be made to the corresponding content in the embodiments described above, which will not be repeated herein.

Further, the terminal is also configured to, before receiving the acquisition instruction sent by the unmanned aerial vehicle, generate a trigger instruction and send the trigger instruction to the unmanned aerial vehicle. The trigger instruction is used to trigger the unmanned aerial vehicle to turn on verification protection function. In some embodiments, the terminal is provided with a trigger button (the trigger button can be set on terminal APP), and the trigger instruction is generated when the trigger button is operated.

S302: Displaying the acquisition instruction.

The terminal can display the acquisition instruction in different manners. For example, an input box generated in response to the acquisition instruction pops up and is used to instruct user to input verification information. As another example, the content of the acquisition instruction is displayed, and the user enters a specific input module on the terminal to input verification information in regard to the acquisition instruction.

S303: Sending the verification information input by the user in regard to the acquisition instruction to the unmanned aerial vehicle.

For process S303, in one embodiment, the terminal forwards the verification information input by the user in regard to the acquisition instruction to the unmanned aerial vehicle. After receiving the verification information sent by the terminal, the unmanned aerial vehicle directly compares the received verification information with preset verification information to determine whether the two match.

In another embodiment, the terminal encrypts the verification information input by the user, and then sends the encrypted verification information to the unmanned aerial vehicle. After decrypting the encrypted verification information received, the unmanned aerial vehicle compares the decrypted verification information with the preset verification information to determine whether the two match.

The terminal in some embodiments may be a mobile terminal (such as a mobile phone or a pad) or a fixed terminal capable of being installed with an APP, and the type of the terminal may be selected according to actual needs.

According to the present disclosure, by creating user operation restrictions on the unmanned aerial vehicle, when the unmanned aerial vehicle is triggered, the user needs to input correct verification information through the terminal before the unmanned aerial vehicle can perform the corresponding operation and/or enable the corresponding function, so as to ensure the safety of the unmanned aerial vehicle. In this way, even if the unmanned aerial vehicle is physically attacked, it can be ensured that the unmanned aerial vehicle will not be illegally operated.

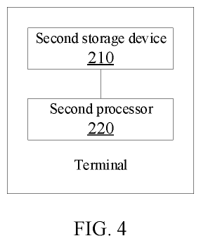

Corresponding to the unmanned aerial vehicle control method in the embodiments described above, the present disclosure also provides a terminal. Referring to FIG. 4, the terminal includes a second storage device 210 and a second processor 220.

The second storage device 210 is configured to store program instructions. The second processor 220 calls the program instructions stored in the storage device and is configured to, when the program instructions are executed, receive the acquisition instruction sent by the unmanned aerial vehicle, the acquisition instruction being used to instruct the terminal to return verification information; display the acquisition instruction; send the verification information input by the user in regard to the acquisition instruction to the unmanned aerial vehicle.

The second processor 220 can implement a corresponding method consistent with the present disclosure such as the method described above in connection with FIG. 3. The unmanned aerial vehicle control method described above can be referred to for details of the operations/functions of the terminal, which will not be repeated herein.

In some embodiments, the second storage device 210 may include a volatile memory such as a random-access memory (RAM). The second storage device 210 may include a non-volatile memory such as a flash memory (flash memory), a hard disk drive (HDD), or a solid-state drive (SSD). The second storage device 210 may include a combination of memories of different types described above.

The second processor 220 may be a central processing unit (CPU). The second processor 220 may include a hardware chip such as an application-specific integrated circuit (ASIC), a programmable logic device (PLD), or a combination thereof. The PLD can be a complex programmable logic device (CPLD), a field-programmable gate array (FPGA), a generic array logic (GAL) or any combination thereof.

It is understandable that the unmanned aerial vehicle control method and the terminal of the present embodiment can be further explained with reference to the embodiments described above.

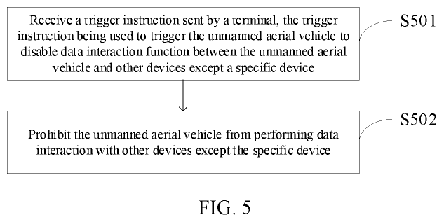

FIG. 5 is a flow chart of another example unmanned aerial vehicle control method consistent with the present disclosure. The execution subject of the unmanned aerial vehicle control method shown in FIG. 5 can be an unmanned aerial vehicle. Referring to FIG. 5, the unmanned aerial vehicle control method includes the following processes.

S501: Receiving a trigger instruction sent by a terminal, the trigger instruction being used to trigger the unmanned aerial vehicle to disable data interaction function between the unmanned aerial vehicle and other devices except a specific device.

The specific device refers to a certain type of device. For example, in some embodiments, the specific device is a remote control, and the unmanned aerial vehicle can only perform data interaction with the remote control, and cannot perform data interaction with other devices other than the remote control.

In some embodiments, the specific device is the terminal that controls the unmanned aerial vehicle, such as a mobile terminal (mobile phone, pad). The unmanned aerial vehicle can only perform data interaction with the terminal, and cannot perform data interaction with other devices other than the terminal.

In some embodiments, the specific device includes remote control and terminal for controlling the unmanned aerial vehicle. The unmanned aerial vehicle can only perform data interaction with the remote control and the terminal, and cannot perform data interaction with other devices other than the remote control and the terminal.

For example, the trigger instruction carries a device identifier of the specific device, and the specific device refers to a device whose device identifier is the device identifier carried by the trigger instruction. The device identification can be a model of the device or other information used to identify the specific device.

S502: Prohibiting the unmanned aerial vehicle from performing data interaction with other devices except the specific device.

S502 specifically includes prohibiting other devices other than the specific device from obtaining data from the unmanned aerial vehicle, and/or prohibiting the unmanned aerial vehicle from receiving data sent by other devices other than the specific device.

By controlling the unmanned aerial vehicle to disable the data interaction function between itself and other devices except the specific device, the data of the unmanned aerial vehicle is prevented from being illegally stolen, the data security of the unmanned aerial vehicle is ensured, and additional safety guarantee is provided for flight operators involved in critical infrastructure, government projects or other sensitive tasks.

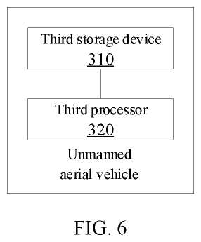

Corresponding to the unmanned aerial vehicle control method in the embodiments described above, the present disclosure also provides an unmanned aerial vehicle. Referring to FIG. 6, the unmanned aerial vehicle includes a third storage device 310 and a third processor 320.

The third storage device 310 is configured to store program instructions. The third processor 320 calls the program instructions stored in the storage device and is configured to receive a trigger instruction sent by a terminal, the trigger instruction being used to trigger the unmanned aerial vehicle to disable data interaction function between the unmanned aerial vehicle and other devices except a specific device; and prohibit the unmanned aerial vehicle from performing data interaction with other devices except the specific device.

In some embodiments, the third storage device 310 may include a volatile memory such as a random-access memory (RAM). The third storage device 310 may include a non-volatile memory such as a flash memory (flash memory), a hard disk drive (HDD), or a solid-state drive (SSD). The third storage device 310 may include a combination of memories of different types described above.

The third processor 320 may be a central processing unit (CPU). The third processor 320 may include a hardware chip such as an application-specific integrated circuit (ASIC), a programmable logic device (PLD), or a combination thereof. The PLD can be a complex programmable logic device (CPLD), a field-programmable gate array (FPGA), a generic array logic (GAL) or any combination thereof.

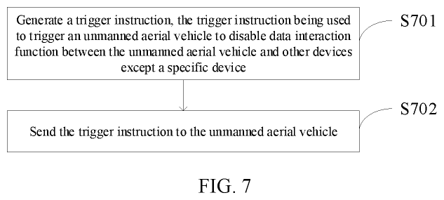

FIG. 7 is a flow chart of another example unmanned aerial vehicle control method consistent with the present disclosure. The execution subject of the unmanned aerial vehicle control method shown in FIG. 7 can be a terminal. Referring to FIG. 7, the unmanned aerial vehicle control method includes the following processes.

S701: Generating a trigger instruction, the trigger instruction being used to trigger an unmanned aerial vehicle to disable data interaction function between the unmanned aerial vehicle and other devices except a specific device.

For example, the terminal is provided with a trigger button (a cover trigger button is provided on terminal APP), the trigger instruction is generated when the trigger button is operated, that is, the unmanned aerial vehicle can be controlled with one-click to disable the data interaction function between it and other devices except the specific device. Of course, in some other embodiments, the terminal can also be triggered in another manner to generate the trigger instruction.

In one embodiment, the trigger button is a button for triggering the terminal to be in an airplane mode.

S702: Sending the trigger instruction to the unmanned aerial vehicle.

By controlling the unmanned aerial vehicle to disable the data interaction function between itself and other devices except the specific device through the terminal, the data of the unmanned aerial vehicle is prevented from being illegally stolen, the data security of the unmanned aerial vehicle is ensured, and additional safety guarantee is provided for flight operators involved in critical infrastructure, government projects or other sensitive tasks.

After the unmanned aerial vehicle receives the trigger instruction sent by the terminal, the unmanned aerial vehicle control method described above can be referred to for details of operations/functions of the unmanned aerial vehicle, which will not be repeated herein.

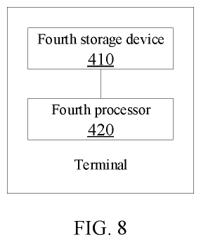

Corresponding to the unmanned aerial vehicle control method in the embodiments described above, the present disclosure also provides a terminal. Referring to FIG. 8, the terminal includes a fourth storage device 410 and a fourth processor 420.

The fourth storage device 410 is configured to store program instructions. The fourth processor 420 calls the program instructions stored in the storage device and is configured to generate a trigger instruction, the trigger instruction being used to trigger an unmanned aerial vehicle to disable data interaction function between the unmanned aerial vehicle and other devices except a specific device; and send the trigger instruction to the unmanned aerial vehicle.

In some embodiments, the fourth storage device 410 may include a volatile memory such as a random-access memory (RAM). The fourth storage device 410 may include a non-volatile memory such as a flash memory (flash memory), a hard disk drive (HDD), or a solid-state drive (SSD). The fourth storage device 410 may include a combination of memories of different types described above.

The fourth processor 420 may be a central processing unit (CPU). The fourth processor 420 may include a hardware chip such as be an application-specific integrated circuit (ASIC), a programmable logic device (PLD), or a combination thereof. The PLD can be a complex programmable logic device (CPLD), a field-programmable gate array (FPGA), a generic array logic (GAL) or any combination thereof.

The terminal in some embodiments may be a mobile terminal (such as a mobile phone or a pad) or a fixed terminal capable of being installed with an APP, and the type of the terminal may be selected according to actual needs.

It is understandable that the unmanned aerial vehicle control method and the terminal of the present embodiment can be further explained with reference to the embodiments described above.

In addition, the present disclosure also provides a computer readable storage medium where a computer program is stored. When the computer program is executed by a processor, processes of a corresponding unmanned aerial vehicle control method consistent with the present disclosure such as any method described above are implemented.

One of ordinary skill in the art can understand that all or part of the processes in the method of the embodiments described above can be implemented by a program instructing relevant hardware, and the program can be stored in a computer readable storage medium. When the program is executed, one or more of the processes in the method of the embodiments can be performed. The storage medium may be a magnetic disk, an optical disk, a read-only memory (ROM), or a random access memory (RAM), etc.

The above are only some embodiments of the present disclosure, which of course are not used to limit the scope of the present disclosure. Therefore, equivalent changes made according to the claims of the present disclosure still fall within the scope of the present disclosure.

What is claimed is:

1. An unmanned aerial vehicle control method comprising:
sending an acquisition instruction to a terminal upon detecting a trigger signal, the acquisition instruction being used to instruct the terminal to return verification information;
receiving the verification information returned by the terminal; and
controlling an unmanned aerial vehicle to perform a corresponding operation and/or enable a corresponding function corresponding to the trigger signal in response to the verification information matching preset verification information.

2. The method of claim 1, wherein:
detecting the trigger signal includes generating the trigger signal in response to the unmanned aerial vehicle meeting a specific strategy; and
the unmanned aerial vehicle meeting the specific strategy includes at least one of:
the unmanned aerial vehicle being currently in a specific location area; or
the unmanned aerial vehicle being currently in a specific time period.

3. The method of claim 1, wherein:
the unmanned aerial vehicle includes a storage device configured to store at least one of image information, audio information, or a flight log;
detecting the trigger signal includes receiving an access request used to instruct an external device to access the storage device; and
controlling the unmanned aerial vehicle to perform the corresponding operation and/or enable the corresponding function includes allowing the external device to access the storage device.

4. The method of claim 3, wherein allowing the external device to access the storage device includes enabling a communication link between the external device and the unmanned aerial vehicle.

5. The method of claim 4, wherein the communication link includes a USB communication link.

6. The method of claim 1, wherein:
detecting the trigger signal includes receiving a power-on request; and
controlling the unmanned aerial vehicle to perform the corresponding operation and/or enable the corresponding function includes starting the unmanned aerial vehicle.

7. The method of claim 1, wherein:
detecting the trigger signal includes receiving a connection request instructing to connect a remote control to the unmanned aerial vehicle; and
controlling the unmanned aerial vehicle to perform the corresponding operation and/or enable the corresponding function includes connecting the remote control to the unmanned aerial vehicle.

8. The method of claim 1, wherein:
detecting the trigger signal includes receiving a verification information modification request instructing to modify the preset verification information; and
controlling the unmanned aerial vehicle to perform the corresponding operation and/or enable the corresponding function includes allowing modification of the preset verification information.

9. The method of claim 8, further comprising, after allowing the modification of the preset verification information:
receiving verification information to be set; and
replacing the preset verification information with the verification information to be set.

10. The method of claim 1, further comprising, before sending the verification request to the terminal:
detecting that the unmanned aerial vehicle has turned on a verification protection function.

11. The method of claim 10, wherein:
detecting the trigger signal includes receiving a shutdown request instructing to turn off the verification protection function; and
controlling the unmanned aerial vehicle to perform the corresponding operation includes turning off the verification protection function.

12. The method of claim 10, further comprising, before detecting that the unmanned aerial vehicle has turned on the verification protection function:
receiving a trigger instruction sent by the terminal, the trigger instruction instructing the unmanned aerial vehicle to turn on the verification protection function; and
turning on the verification protection function in response to the trigger instruction.

13. The method of claim 1, wherein the verification information matching the preset verification information includes the verification information being same as the preset verification information.

14. The method of claim 1, further comprising, after receiving the verification information returned by the terminal:
locking the corresponding operation and/or function of the unmanned aerial vehicle in response to the verification information not matching the preset verification information.

15. An unmanned aerial vehicle comprising:
a storage device storing preset verification information; and
a processor electrically coupled to the storage device and configured to:
send an acquisition instruction to a terminal upon detecting a trigger signal, the acquisition instruction being used to instruct the terminal to return verification information;
receive the verification information returned by the terminal; and
control the unmanned aerial vehicle to perform a corresponding operation and/or enable a corresponding function corresponding to the trigger signal in response to the verification information matching the preset verification information.

16. The unmanned aerial vehicle of claim 15, wherein the processor is configured to generate the trigger signal in response to the unmanned aerial vehicle meeting a specific strategy.

17. The unmanned aerial vehicle of claim 16, wherein the unmanned aerial vehicle meeting the specific strategy includes at least one of:
the unmanned aerial vehicle being currently in a specific location area; or
the unmanned aerial vehicle being currently in a specific time period.

18. The unmanned aerial vehicle of claim 15, wherein the processor is configured to determine that the trigger signal is detected in response to receiving an operation request.

19. The unmanned aerial vehicle of claim 18, wherein:
the unmanned aerial vehicle includes a storage device configured to store at least one of image information, audio information, or a flight log;
the operation request includes an access request used to instruct an external device to access the storage device; and
the processor is configured to allow the external device to access the storage device.

20. A terminal comprising:
a storage device storing program instructions; and
a processor configured to execute the program instructions stored in the storage device to:
receive an acquisition instruction sent by an unmanned aerial vehicle, the acquisition instruction being used to instruct the terminal to return verification information;
display the acquisition instruction; and
send the verification information input by user in regard to the acquisition instruction to the unmanned aerial vehicle.
